(19) United States
(12) Patent Application Publication
(10) Pub. No.: US 2007/0130133 A1
(43) Pub. Date: Jun. 7, 2007

(54) Incorporating network constraints into a network data model for a relational database management system

(75) Inventors: Frank Lee, Carlisle, MA (US); Ning An, Nashua, NH (US); Cheng-Hua Wang, Bedford, NH (US)

Correspondence Address: GORDON E. NELSON, PATENT ATTORNEY, PC, 57 CENTRAL STREET, P.O. BOX 782, ROWLEY, MA, 01969, US

(73) Assignee: Oracle International Corporation

(21) Appl. No.: 11/293,487

(22) Filed: Dec. 2, 2005

(51) Int. Cl. G06F 17/30

(52) U.S. Cl. 707/4

(57) ABSTRACT

A technique used with PL/SQL routines that are wrappers for Java routines which permits a PL/SQL wrapper routine to supply a Java class to the Java routine executed by the wrapper routine. The invocation of the wrapper routine includes a parameter value that specifies the class. The relational database system in which the PL/SQL routine is being executed includes a row source for a row that relates the parameter value to a definition for the class that is to be supplied. When the PL/SQL routine is executed, the PL/SQL routine uses the parameter value to query the row source and provides the class definition returned by the query to the Java routine. The technique is employed in a network analysis API that is made up of PL/SQL wrapper routines to supply classes defining network constraints to the Java routines executed by the wrapper routines.

### CROSS-REFERENCE TO RELATED APPLICATIONS

The present patent application is a further development of the network data model disclosed in U.S. Ser. No. 10/696,482, Wang, et al., Network data model for a relational database management system, filed Oct. 29, 2003 and published May 5, 2005 as US 2005/0097108 A1. Extensive portions of U.S. Ser. No. 10/696,482 have been included in the Background of the invention in the present patent application and all of U.S. Ser. No. 10/696,482 is incorporated by reference herein for all purposes.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

This invention relates to electronic data processing systems, and more particularly to systems for modeling relationships between objects as networks and analyzing the networks.

2. Description of Related Art

U.S. Ser. No. 10/696,482 provides methods and apparatus for modeling a set of nodes and links that together form a network. Each node represents an object of interest and each link represents a relationship between two nodes. Network analysis procedures provided by the data model often produce result data which defines a specific path, an alternating sequence of nodes and links, beginning and ending with nodes, and typically with no nodes and links appearing more than once.

The network modeling system disclosed in U.S. Ser. No. 10/696,482 forms a part of and extends the functionality of a relational database management system (RDBMS). More specifically, the network modeling system disclosed in U.S. Ser. No. 10/696,482 is implemented as an extension to an Oracle®10^{gR1} database employing Oracle Spatial, an integrated set of functions and procedures that enables spatial data to be stored, accessed, and analyzed quickly and efficiently. Oracle Spatial as disclosed in U.S. Ser. No. 10/696,482 is described in detail in the Oracle Spatial User's Guide and Reference, Release 9.2, March 2002, Part No. A96630-01, which provides usage and reference information for indexing and storing spatial data and for developing spatial applications using Oracle Spatial. Oracle Spatial requires the Oracle 10^{gR1} Enterprise Edition RDBMS and provides a foundation for the deployment of enterprise-wide spatial information systems and Web-based and wireless location-based applications requiring complex spatial data management. Oracle Spatial, and the Oracle10^{g} Enterprise Edition database relational database management system (RDBMS) product with which it works, are available from Oracle Corporation, Redwood Shores, Calif. Oracle Spatial provides a standard data type for defining spatial geometries, as well a variety of standard procedures for manipulating geometry data, which are used to advantage in connection with the network modeling system. Pertinent features of Oracle Spatial and the geometry data type SDO_GEOMETRY which it defines are fully described in detail in the above-noted Oracle Spatial User's Guide and Reference and are summarized briefly below. The network modeling system provides a shareable application program interface (API) and network data model infrastructure which is used in combination with a relational database, such as the Oracle1₀^{gR1} Enterprise Edition with Oracle Spatial, to provide a consistent data model and processing functions for network data.

Introduction to Network Modeling

In many applications, capabilities or objects are modeled as nodes and links in a network. The network model contains logical information such as connectivity relationships among nodes and links, directions of links, and costs of nodes and links. With logical network information, the user can analyze a network and answer questions, many of them related to path computing and tracing. For example, for a biochemical pathway, the user can find all possible reaction paths between two chemical compounds. For a road network, the user can find the shortest (distance) or fastest (travel time) path between two cities, or the closest hotel to a specific airport.

In additional to logical network information, spatial information such as node locations and link geometries can be associated with the logical network. This information can help the user to model the logical information (such as the cost of a route, because the route's physical length can be directly computed from its spatial representation).

The generic data model and network analysis capability provided by the network modeling system can model and analyze many kinds of network applications in addition to traditional geographical information systems (GIS). For example, in biochemistry, applications may need to model reaction pathway networks for living organisms; and in the pharmaceutical industry, applications to model the drug discovery process may need to model protein-protein interaction.

The network modeling capabilities provided by the network modeling system include schema objects and an application programming interface (API). The schema objects include metadata and network tables. The API includes a server-side PL/SQL API for creating, managing, and analyzing networks in the database, and a middle-tier (or client-side) Java™ API for network analysis.

There are two basic approaches to creating a network data model: the user can request the system to perform most operations, using standard stored procedures, or the user can perform the operations by creating the necessary network tables and updating the network metadata. With each approach, the user must insert the network data into the network tables. Optionally the user can create an in-memory network object using the Java application programming interfaces (API) and save it to the database. The user may then use the network data model PL/SQL and Java application programming interfaces (APIs) to update the network and perform other operations.

Network Data Model Concepts and Definitions

A network is a type of mathematical graph that captures relationships between objects using connectivity. The connectivity may or may not be based on spatial proximity. For example, if two towns are on opposite sides of a lake, the shortest path based on spatial proximity (a straight line across the middle of the lake) is not relevant if the user wants to drive from one town to the other. Instead, to find the shortest driving distance, the user needs connectivity information about roads and intersections and about the “cost” of individual links.

A network consists of a set of nodes and links. Each link (sometimes also called an edge or a segment) connects two nodes. A network can be directed or undirected, although links and paths typically have direction.

In describing the preferred network data model embodying the invention, it will be useful to first define some key terms used in this specification to describe the network data model. Unless otherwise apparent from the context, each of the following terms has the following meanings:

A “node” represents an object of interest.

A “link” represents a relationship between two nodes. A link may be directed (that is, have a direction) or undirected (that is, not have a direction).

A “path” is an alternating sequence of nodes and links, beginning and ending with nodes, and typically with no nodes and links appearing more than once.

A “network” contains a set of nodes and links. A network is directed if the links that is contains are directed, and a network is undirected if the links that it contains are undirected.

A “logical network” contains connectivity information but no geometric information. This is the model used for network analysis. A logical network can be treated as a directed graph or undirected graph, depending on the application.

A “spatial network” contains both connectivity information and geometric information. The geometric information is geometric representations of shapes that are associated with a nodes, links, or paths. The geometric representation employs some kind of coordinate space. For example, in a transportation network, geometric information includes geometric representations of exits and intersections (mapped to nodes), and highways and streets (mapped to links or paths).

“Cost” is a non-negative numeric attribute that can be associated with links or nodes for computing such things as the minimum cost path (the path that has the minimum total cost from a start node to an end node). The user can specify a single cost factor, such as driving time or driving distance for links, in the network metadata.

“Reachable nodes” are all nodes that can be reached from a given node. “Reaching nodes” are all nodes that can reach a given node.

The “degree” of a node is the number of links to (that is, incident upon) the node. The in-degree is the number of inbound links, and the out-degree is the number of outbound links.

“Network constraints” are restrictions defined on network analysis computations (for example, that driving routes must consist of expressways and major highways).

A “spanning tree” of a connected graph is a tree (that is, a graph with no cycles) that connects all nodes of the graph. (The directions of links are ignored in a spanning tree.)

A “minimum cost spanning tree” is the spanning tree that connects all nodes and has the minimum total cost.

Network Applications

Networks are used in applications to find how different objects are connected to each other. The connectivity is often expressed in terms of adjacency and path relationships. Two nodes are adjacent if they are connected by a link. There are often several paths between any two given nodes, and the user may want to find the path with the minimum cost. This section describes some typical examples of different kinds of network applications.

Road Network Example. In a typical road network, the intersections of roads are nodes and the road segments between two intersections are links. The spatial representation of a road is not inherently related to the nodes and links in the network. For example, a shape point in the spatial representation of a road (reflecting a sharp turn in the road) is not a node in the network if that shape point is not associated with an intersection; and a single spatial object may make up several links in a network (such as a straight segment intersected by three crossing roads). An important operation with a road network is to find the path from a start point to an end point, minimizing either the travel time or distance. There may be additional constraints on the path computation, such as having the path go through a particular landmark or avoid a particular intersection.

Train (Subway) Network Example. The subway network of any major city can be modeled as a logical network, assuming that precise spatial representation of the stops and track lines is unimportant. In such a network, all stops on the system constitute the nodes of the network, and a link is the connection between two stops if a train travels directly between these two stops. Important operations with a train network include finding all stations that can be reached from a specified station, finding the number of stops between two specified stations, and finding the travel time between two stations.

Utility Network Example. Utility networks, such as power line or cable networks, must often be configured to minimize the cost. An important operation with a utility network is to determine the connections among nodes, using minimum cost spanning tree algorithms, to provide the required quality of service at the minimum cost. Another important operation is reachability analysis, so that, for example, if a station in a water network is shut down, the user knows which areas will be affected.

Biochemical Network Example. Biochemical processes can be modeled as biochemical networks to represent reactions and regulations in living organisms. For example, metabolic pathways are networks involved in enzymatic reactions, while regulatory pathways represent protein-protein interactions. In this example, a pathway is a network; genes, proteins, and chemical compounds are nodes; and reactions among nodes are links. Important operations for a biochemical network include computing paths and the degrees of nodes.

Network Data Model Tables

The network modeling system may be used to store and analyze data describing a network. A simple logical network is shown in FIG. 1 consisting of three nodes designated by Node ID values 1, 2 and 3 and by node Name values “N1”, “N2” and “N3” respectively. The network is not directed, i.e., all links can be traversed in both directions. The connectivity information for the network of FIG. 1 is stored in two tables: a node table and a link table, illustrated in simplified form in FIGS. 2 and 3 respectively. In addition, path information can be stored in a path table shown illustrated in FIG. 4 and a path-link table illustrated in FIG. 5. As shown in FIGS. 1 and 3, the link named “L1” is a straight line connecting nodes N1 and N2, link “L2” is a straight line connecting nodes N2 and N3, and link “L3” is a straight line connecting nodes N3 and N1. There are no other nodes on any of the links.

The user may request the system to create these tables automatically when creating the network using a standard procedure (named “CREATE_<network-type>_NETWORK”) which is available via the PL/SQL interface, or the user can create these tables using individual node table, link table, path table and path-link table creation procedures also provided by the PL/SQL interface. The tables can also be created using create elements methods provided by the Java API.

These tables contain columns with predefined names, and the user must not change any of the predefined column names (which will be referenced by standard procedures); however, the user can add columns to the tables by using an ALTER TABLE PL/SQL statement with the ADD COLUMN clause. For example, although each link and path table is created with a single COST column, the user can create additional columns and associate them with other comparable attributes. For example, if the user wanted to assign a driving time, scenic appeal rating, and a danger rating to each link, the user could use the COST column for driving time, add columns for SCENIC_APPEAL and DANGER to the link table, and populate all three columns with values to be interpreted by applications. Because the connectivity data used by the network data model are stored as standard RDBMS tables, the data may be manipulated using the robust capabilities of the database system, including a rich set of standard PL/SQL procedures as described, for example in Oracle10g: The Complete Reference by Kevin Loney, McGraw-Hill Osborne Media; Book and CD edition ISBN: 0072253517 (May 5, 2004).

Node Table

Each network has a node table. Each row of the node table represents a node in the network. A node table containing rows for the nodes of the simple logical network of FIG. 1 is shown in FIG. 2. The network of FIG. 1 is a logical network, has only a single node type, and has only a single level; consequently, the type, geometry, level, and parent fields are unused. When used, the geometry field here and in the other tables contains a value which represents the geometric information that is associated with the network component represented by the row to which the geometry field belongs.

Link Table

Each network has a link table. There is a row in the link table for each link in the network. FIG. 3 shows a link table for the links of the simple network of FIG. 1. Again, because the network of FIG. 1 is a logical network that is not directed and has only a single link type and a single level, the type, level, geometry, and parent fields are not used. When the network the link table belongs to is directed, a field (not shown in FIG. 3) in each row of the link table indicates whether the link may be traversed only from its start node to its end node or in either direction.

Path Table

Each network may have a path table. A path is an ordered sequence of links that is generally created as a result of network analysis. The path table has a row for each path; the row contains an ID for the path, the name of the path, the start node and end node for the path, the cost of the path, whether the path is simple or complex, and whether there is a geometry object associated with the path. FIG. 4 shows a path table for the simple network of FIG. 1. Again, the type and geometry fields are not used.

Path-link Table

For each path table, the user must create a path-link table. Each row in the path-link table uniquely identifies a link that belongs to a given path in a network. The row contains the path's ID, the link's ID, and a unique sequence number. The sequence number permits a path to visit a node or a link more than once. FIG. 5 shows a path-link table for the simple network of FIG. 1.

Network Hierarchy

Some network applications require representations at different levels of abstraction. For example, two major processes might be represented as nodes with a link between them at the highest level of abstraction, and each major process might have several subordinate processes that are represented as nodes and links at the next level down.

A network hierarchy allows the user to represent a network with multiple levels of abstraction by assigning a hierarchy level to each node. Links are not assigned a hierarchy level, and links can be between nodes in the same hierarchy level or in different levels. The lowest (most detailed) level in the hierarchy is level 1, and successive higher levels are numbered 2, 3, and so on. Nodes at adjacent levels of a network hierarchy have parent-child relationships. Each node at the higher level can be the parent node for one or more nodes at the lower level. Each node at the lower level can be a child node of one node at the higher level. Links can also have parent-child relationships. However, because links are not assigned to a hierarchy level, there is no necessary relationship between link parent-child relationships and network hierarchy levels.

FIG. 6 shows a simple hierarchical network, in which there are two levels: Level 1 and Level 2. The top level (level 1) contains two nodes 601 and 602. Each node is the parent node of several nodes in the bottom level. The link 605 between the nodes in the top level is the parent link of two links 607 and 609 between nodes in the bottom level. The bottom level (level 2) shows the nodes that make up each node in the top level. It also shows the links between nodes that are child nodes of each parent node in the top level, and the two links 607 and 609 between nodes that have different parent nodes and are child links of the single link between the nodes in the top level in the hierarchy. (However, these two links in the bottom level could also be defined as not being child links of any parent link between nodes in a higher level.)

The parent-child relationships between each parent node and link and its child nodes and links are shown with dashed lines with arrowheads at both ends. Although not shown in FIG. 6, links can cross hierarchy levels. For example, a link could be defined between a node in the top level and any node in the bottom level.

APIs for the Network Data Model

In the network data model disclosed in U.S. Ser. No. 10/696,482, there were two APIs (application program interfaces) for the network data model: one in PL/SQL and one in Java. PL/SQL is a programming language used in relational database management systems. The PL/SQL API included routines which permitted application programs to create, access, and manage networks made according to the network data model in the relational database management system. The PL/SQL API did not, however, include routines for analyzing the networks. The network analysis had to be done using the Java API.

Java is a well-known general-purpose object-oriented programming language. The Oracle 10^{gR1} relational database management system in which the network data model of U.S. Ser. No. 10/696,482 was implemented included a Java compiler and a Java virtual machine, which executed the code produced by the Java compiler. The Java API ran on the Java virtual machine. It could be used not only for network analysis, but also for all of the operations that the PL/SQL API could perform. Users of the network model could also employ Java to make network constraints for use in network analysis.

The need to use the Java API to do network analysis seriously reduced the usability of the network data model. Programmers who work with relational database management programs normally program in PL/SQL; even for those who know Java, Java is a second language. Java programmers, on the other hand, are generally not familiar with relational database management systems; consequently, though they understood the language the Java API was written in, they had difficulties understanding the systems in which the API was to be used. What was needed was a PL/SQL API that could be used not only create, manage, and access the networks, but also to do network analysis using network constraints implemented as Java classes. It is an object of the invention disclosed herein to provide such a PL/SQL API.

### BRIEF SUMMARY OF THE INVENTION

The object is attained by a technique used with PL/SQL routines that are wrappers for Java routines for supplying a Java class to the Java routine. The PL/SQL routine and the Java routine are executed in a relational database system. In the technique, a parameter value that specifies the class that is to be supplied is available to an execution of the PL/SQL routine and the relational database system includes a source of a row that relates the parameter value to a class definition for the class that is to be supplied. The execution of the PL/SQL routine queries the source of the row using the parameter value and provides the related class definition to an execution of the Java routine for use in the Java routine's execution.

In other aspects, the technique includes associating the execution of the PL/SQL routine with an entity that may execute routines in the relational database management system. The row that relates the parameter value to the class definition also relates the parameter value to the entity and the execution of the PL/SQL routine queries the source of the row using both the parameter value and the entity.

The technique also includes a registration PL/SQL routine that creates the row in the row source in response to a specification of the class definition and the parameter value and a deregistration routine that deletes the row in the row source in response to the parameter value.

One application of the technique is with PL/SQL routines belonging to a network analysis API that is used in the relational database system to analyze a network represented by a network data model for which the data is contained in tables in the relational database system. In this application, the parameter values specify network constraints used in network analysis, the row source is part of the metadata for the network data model, and the rows of the row source relate the parameter values to class definitions for the network constraints. In a particular version of the application, the row source relates an owner of the class to the parameter value and the class definition and the metadata further includes a writable view of the row source and a read only view of the row source. The writable view includes rows belonging to a given owner. The rows include the parameter values and the class definitions. The rows of the readable view include the parameter value but neither the owner nor the class definition.

### BRIEF DESCRIPTION OF THE SEVERAL VIEWS OF THE DRAWINGS

FIG. 1 illustrates a simple logical network which is described using the tables shown in FIGS. 2-5;

FIG. 2 illustrates the makeup of a node table;

FIG. 3 illustrates a link table;

FIG. 4 illustrates a path table;

FIG. 5 shows a path-link table;

FIG. 6 shows a network organized in a hierarchy;

FIG. 7 shows a relational database management system that includes a network data model;

FIG. 8 shows a Unified Modeling Language diagram of how a network constraint is incorporated into the system of FIG. 7;

FIG. 9 shows the metadata that is used to incorporate network constraints into a network data model;

FIG. 10 shows a function for a network analysis operation that includes a network constraint;

FIG. 11 shows an example of a network to which a network constraint applies; and

FIG. 12 is an example of the implementation of the constraint and its use to analyze the network of FIG. 11.

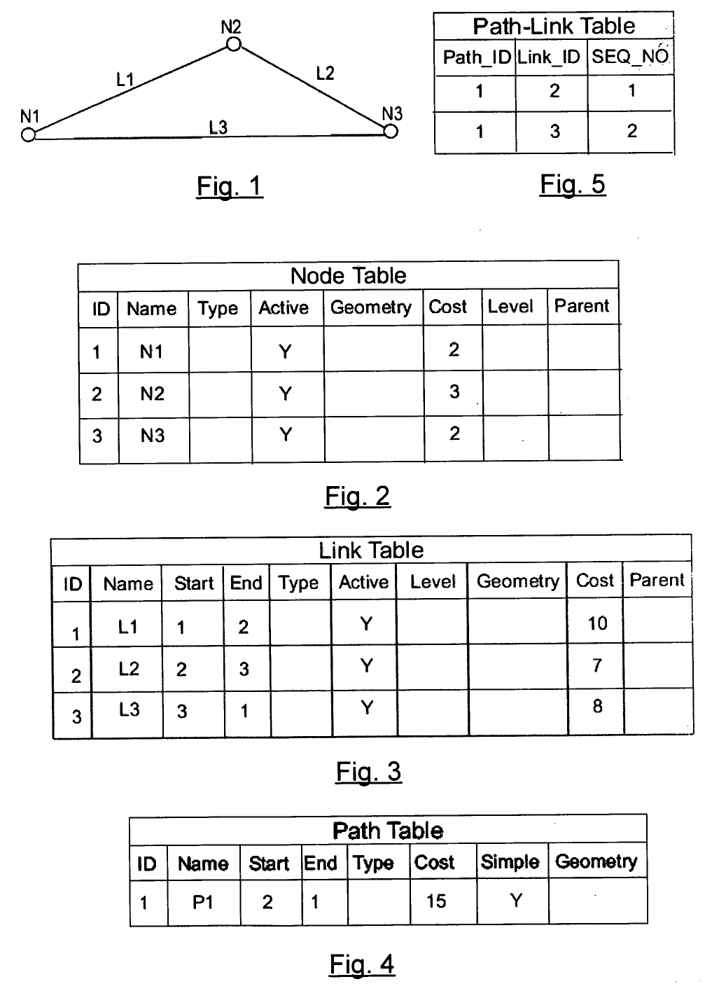

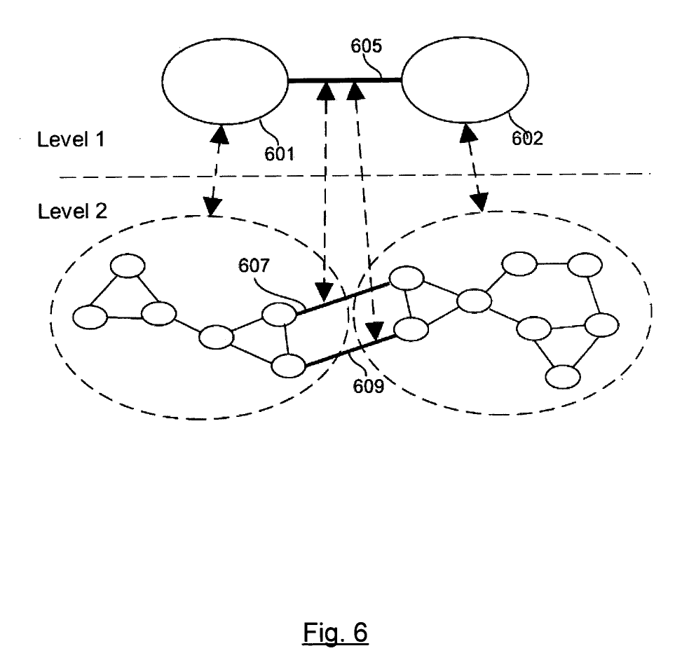

### DETAILED DESCRIPTION OF THE INVENTION

The PL/SQL Network Data Model API

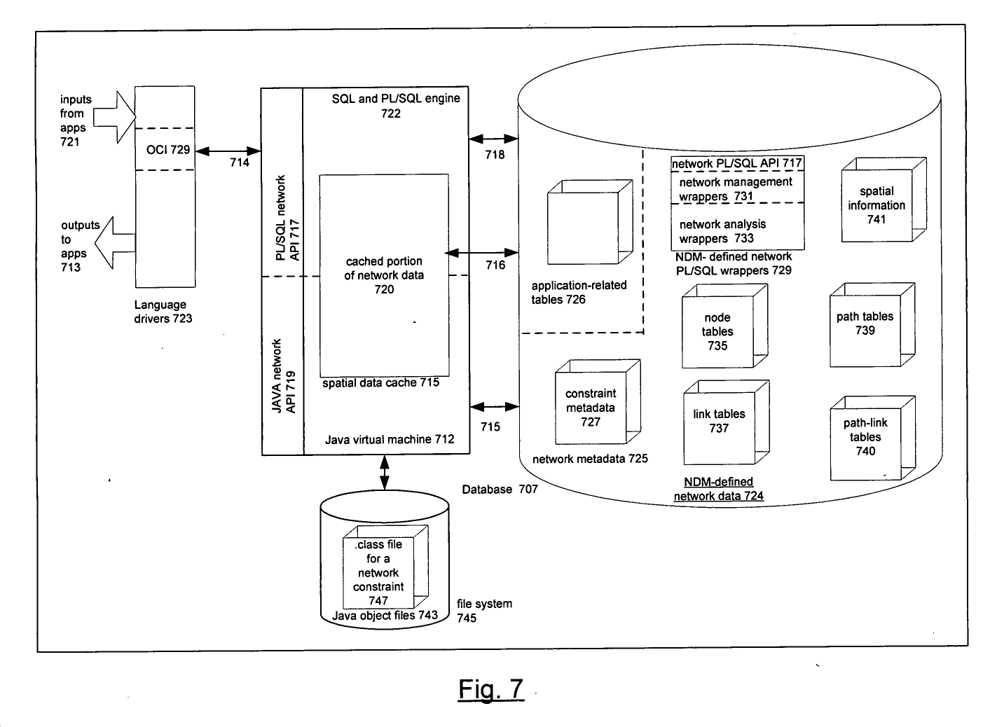

PL/SQL is a procedural language superset of the structured query language (SQL). As implemented in the Oracle10^{g} RDBMS, PL/SQL may be used to codify business rules through the creation of stored procedures and packages, to trigger database events to occur, or to add programming logic to the execution of SQL commands. The network data model PL/SQL API provides functions and procedures for creating, accessing, managing, and analyzing networks on a database server. These functions and procedures can be grouped into the following logical categories: (a) creating networks; (b) copying and deleting networks: (c) creating network tables; (d) validating network objects; (e) retrieving information (getting information about the network, checking for a characteristic), and (f) analyzing networks. The user can use the Java API to perform the same operations as can be done using PL/SQL. The analysis operations include the following:
Shortest path (for directed and undirected networks): typical transitive closure problems in graph theory. Given a start and an end node, find the shortest path.
Minimum cost spanning tree (for undirected networks): Given an undirected graph, find the minimum cost tree that connects all nodes.
Reachability: Given a node, find all nodes that can reach that node, or find all nodes that can be reached by that node.
Within-cost analysis (for directed and undirected networks): Given a target node and a cost, find all nodes that can be reached by the target node within the given cost.
Nearest-neighbors analysis (for directed and undirected networks): Given a target node and number of neighbors, find the neighbor nodes and their costs to go to the given target node.
All paths between two nodes: Given two nodes, find all possible paths between them.
“Traveling salesman problem” (TSP) analysis: Given a set of nodes, find the most efficient (lowest-cost or shortest distance) path that visits all nodes, and optionally require that the start and end nodes be the same.
   Overview of a RDBMS Server in Which the Network Data Model is Implemented: FIG. 7

Shown at 701 in FIG. 7 is a high-level overview of an Oracle 10gR2 object-relational database server 702 in which the version of the network data model described in the following is implemented. Server 702 is designed to respond to inputs from application programs 721 and provide outputs 713 to those application programs; in many applications, the applications run on client systems and the inputs 721 and outputs 713 are transferred to and from server 702 via a network. Increasingly, the network employs the Internet Protocol. The inputs 721 may be in many different programming languages or protocols and are interpreted by language drivers 723 and provided to processing components in the server, as shown at 714. One such driver 729 is shown, for the Oracle command interface, which interprets inputs in the SQL and PL/SQL languages. There is another such driver for inputs in Java.

SQL and PL/SQL produced by language drivers 723 is executed by SQL and PL/SQL engine 722; Java produced by language drivers 723 is executed by Java virtual machine 712. When SQL and PL/SQL engine 722 is part of a server 702 in which the network data model has been implemented, engine 722 presents the PL/SQL network data model API 717 to the application programs; similarly, when Java virtual machine 712 is part of such a server, virtual machine 712 presents the Java network data API 719 to the application programs. Both engine 722 and virtual machine 712 have access to spatial data cache 715, which is a memory cache in which network data 720 that is being analyzed is cached. The PL/SQL programs executed by engine 722 are stored in database 707; shown there at 729 are the PL/SQL programs that implement the PL/SQL network data model API. The Java objects for the Java programs executed by the Java virtual machine are contained in files 743 in a file system 745 that is accessible to server 702. Among the Java objects are those which implement Java network data API 719

Database 707 contains the tables for the NDM-defined network data at 724 and the application-related tables 726 which applications use as they manipulate the NDM-defined data. Each network specified in network data 724 includes the following kinds of tables:
a node table 735 which contains a row for each row in the network;
a link table 737 which contains a row for each link in the network;
a path table 739 which contains a row for each path in the network; and
a path-link table 740 which contains a row for each link in each path in the network; In addition, there is a set of network metadata tables which contains metadata about each of the networks. Included in the metadata are attributes of each network such as the network's name, its owner, what kind of network it is, and descriptions of the tables for each of the networks. Also included in the metadata are indexes on the network's tables and as shown at 727, tables and views specifying the network constraints for a network. Spatial information 741 contains the spatial information represented by values in the “geometry” columns of the node, link, and path tables.

NDM-defined network PL/SQL wrappers, finally, contain PL/SQL wrappers for the Java objects making up Java network data API 719. These wrappers are PL/SQL programs belonging to or used by PL/SQL network API 717 which invoke the corresponding Java programs that belong to or are used by Java network API 719. It is these wrappers which make it possible for users of server 702 to use PL/SQL API 717 not only to do network management functions, but also to do network analysis functions. The wrappers for the two kinds of functions are shown at 731 and 733.

With regard to network data 724, server 702 operates in two modes: a network management node in which a network may be defined and the data making up the network may be written to or read from the network and an analysis mode in which the analysis operations described above may be performed on the network. Either PL/SQL API 717 or Java API 719 may be used in either mode. Operations belonging to the network management mode are performed by the routines of the APIs directly on the tables of NDM-defined network data 724, as shown by arrows 718 and 715.

Operations belonging to the network analysis operations are performed on network data that is copied from tables 735, 737, 739, and 740 into cached network data 720; consequently, before a network analysis operation can be performed, a routine of the API must be executed which copies a network or a layer of a network into cache 715. When the network or layer has been copied into the cache, the cache includes all of the rows from network metadata 725, node tables 735, link tables 737, spatial information tables 741, path tables 739, and path-link tables 740 which are relevant to the copied network or layer. In a preferred embodiment, cache 715 is implemented in memory belonging to server 702. The analysis operations are then performed on the data in the cache. The analysis operations include operations which alter the nodes, links, and paths of the network in the copy 720 of the network in cache 715; to preserve these alterations, a routine of the API must be executed which saves the current contents of cache 720 to the tables in NDM-defined network data 724. Once a network has been created, all of the management operations can be performed either in network management or network analysis mode; if only a few management operations are to be performed, doing them in network management mode avoids the overhead of setting up cache 715, copying the network into the cache, and copying it back after the management operations have been performed; if many management operations are to be performed, the greater speed with which the operations are performed in cached copy 720 more than make up for the overhead of making the cached copy and writing the cached copy back to NDM-defined network data 724.

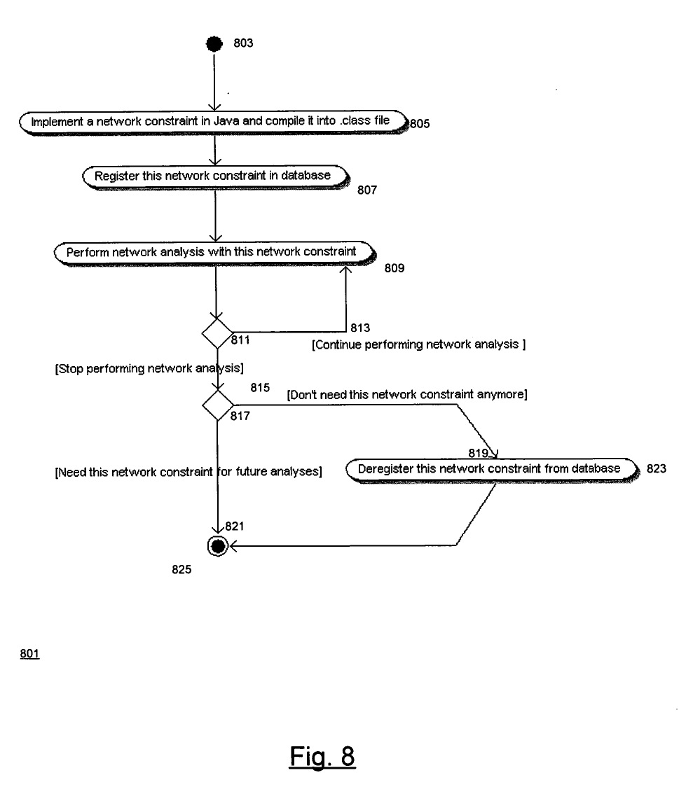

Integrating Network Constraints into the PL/SQL API: FIG. 8

The Problem

As pointed out in the Description of related art, a network constraint is a restriction defined on network analysis computations. An example of such a constraint is a restriction on the directions of turns in an intersection. In server 702, a network constraint is implemented as a Java class. The definition for a Java class is contained in a class file. In server 702, the class files are contained in files 743 in file system 745. The class definition in the .class file will generally include an object definition for a constraint information object that contains the information needed to determine where the constraint applies and Java code for operations on the object. Included in the operations are making a constraint information object, writing constraint information to the object associated with the network, and using the constraint information in the object to determine the effect of the constraint on a network analysis. In a presently-preferred embodiment, all constraints are global, that is, they can be applied to any network made according to the network data model in server 702. In other embodiments, constraints may be defined that are particular to a given network. In the presently-preferred embodiment, each constraint has an owner, i.e., an entity in server 702 that has access to the network data model. A given constraint may be applied to a network only by the constraint's owner.

As pointed out in the Description of related art, in U.S. Ser. No. 10/696,482, everything connected with network analysis was done using Java. Constraints were implemented as Java classes and network analysis was done using the Java API. The requirement that network analysis be done using Java seriously reduced the usability of the network modeling system for users of relational database systems whose primary programming language was PL/SQL. To solve the usability problem, two things were done:
a PL/SQL API for network analysis was implemented by means of PL/SQL wrapper routines for the Java network analysis routines.
while the constraints were still implemented as Java classes, a way was found to register the constraints with the PL/SQL API so that they could be used as parameters in the PL/SQL network analysis wrappers.
   An advantage of the registration technique for constraints was that it could be used to register constraints made available for special purposes by third parties, and consequently permitted PL/SQL programmers with no experience either in Java or in implementing constraints to use third party constraints while doing network analysis in PL/SQL.

Registration of the constraints with the PL/SQL API is necessary because the wrapper routines that make up the PL/SQL API cannot interpret the data structures in the Java class definition for the constraint's class, and consequently, the PL/SQL API routines that can take constraint parameters must provide a copy of the class definition for the constraint specified in the constraint parameter to the Java routine that underlies the PL/SQL wrapper routine. The Java virtual machine can then employ the class definition for the constraint in its execution of the Java routine.

Constraint Registration and Constraint Metadata: FIG. 8

In server 702, constraints are registered in constraint metadata tables 727. In overview, each row of these tables represents a network constraint and contains information that a PL/SQL wrapper routine can pass into the underlying Java routine to make the Java class that implements the network constraint available to the underlying Java routine. When a constraint is registered with the PL/SQL API, a row for the network constraint is made in the constraint metadata tables 727. This is done using a registration routine in the PL/SQL API. Once a network constraint has been registered, it can be used as a parameter for the PL/SQL API analysis routines that permit specification of a network constraint. When a network constraint is no longer needed, it can be deregistered, again by means of a deregistration routine in the PL/SQL API. Deregistration simply deletes the constraint's row in metadata tables 727.

FIG. 8 presents a universal modeling language (UML) activity graph 801 of the process of implementing, registering, using, and deregistering a network constraint. Graph 801 is read in substantially the same fashion as a flowchart. Starting at start indicator 803, the first step 805 is writing the Java code for the network constraint's data and operations and compiling the code into a Java class file. Next, the network constraint is registered by making an entry for it in constraint metadata 727 (807). Once this has been done, the PL/SQL API's network analysis routines can use the constraint's name as a constraint parameter (809) and as indicated by decision box 811 and arrow 813, the constraint's name can be used as a parameter in analysis routines as long as analysis of the network currently cached in cache 715 continues. After the network analysis is finished (815), the network constraint may be retained in constraint metadata 727 for future use (817, 821) or may be deregistered, i.e., removed from constraint metadata 727 (817, 819, 823). Activity graph 801 ends at 825.

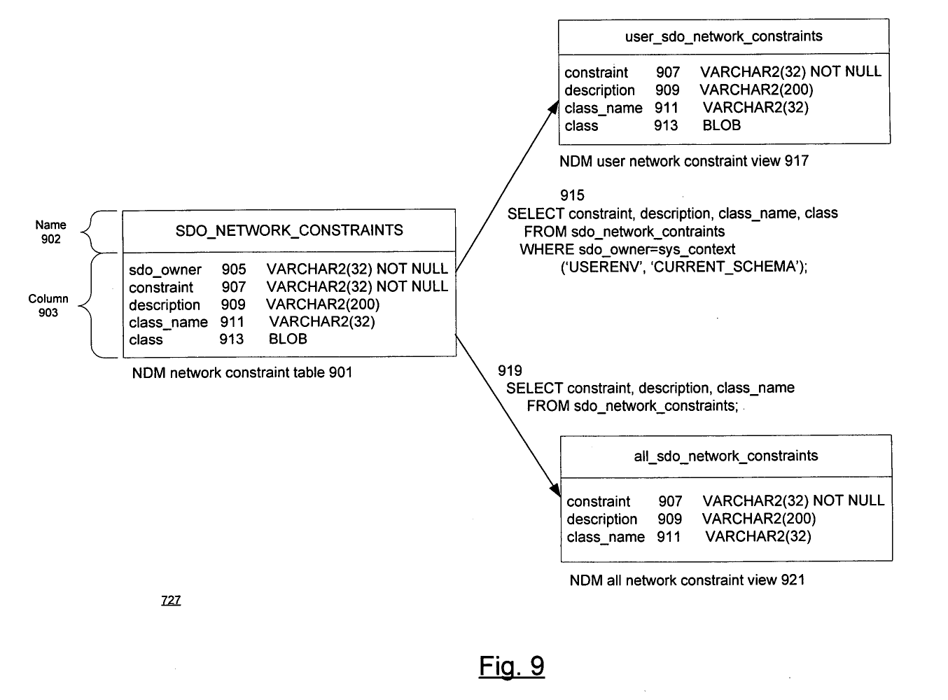

Details of Constraint Metadata 727: FIG. 9

FIG. 9 shows how constraint metadata 727 is implemented in a preferred embodiment of server 702. Constraint metadata 727 is made up of a NDM network constraint base table 901 called SDO_NETWORK_CONSTRAINTS, which has a row for each constraint that is registered with server 902 and two views of base table 901, NDM user network constraint view 917 and NDM all network constraint view 921. In the representation of the table and views used in FIG. 9, the table or view's name as shown at 902 and the table's columns are shown at 903. A row of the table has a field for each of the columns. User network constraint view 917 is a view of base table 901 which shows the rows of table 901 for network constraints belonging to a particular user. User constraint view 917 gives the owner of the network constraint all of the information he or she needs to manipulate the network constraint. Accordingly, the owner may perform select, insert, delete, and update operations on view 917; with the insert, delete, and update operations, triggers perform the equivalent operations on base table 901. All network constraint view 921 shows selected fields from all of the rows of table 901. This view is available to any user of the network data model in server 702. Users may only perform select operations on view 921. The query used to make view 917 is shown at 915; the query used to make view 921 is shown at 919.

Continuing with the details of the columns in base table 901, there is an owner column 905 whose values represents owners of network constraints, a constraint column 907 whose values are the network constraint names that are used as parameters in PL/SQL routines, description column 909, whose values are owner-provided descriptions of the network constraints, class_name column 911, whose values are the name (minus the .class suffix) of the .class files 747 in Java object files 743 that define the classes of the constraints, and class column 913, whose values are bit large objects (blobs) that contain copies of the contents of the constraints'.class files.

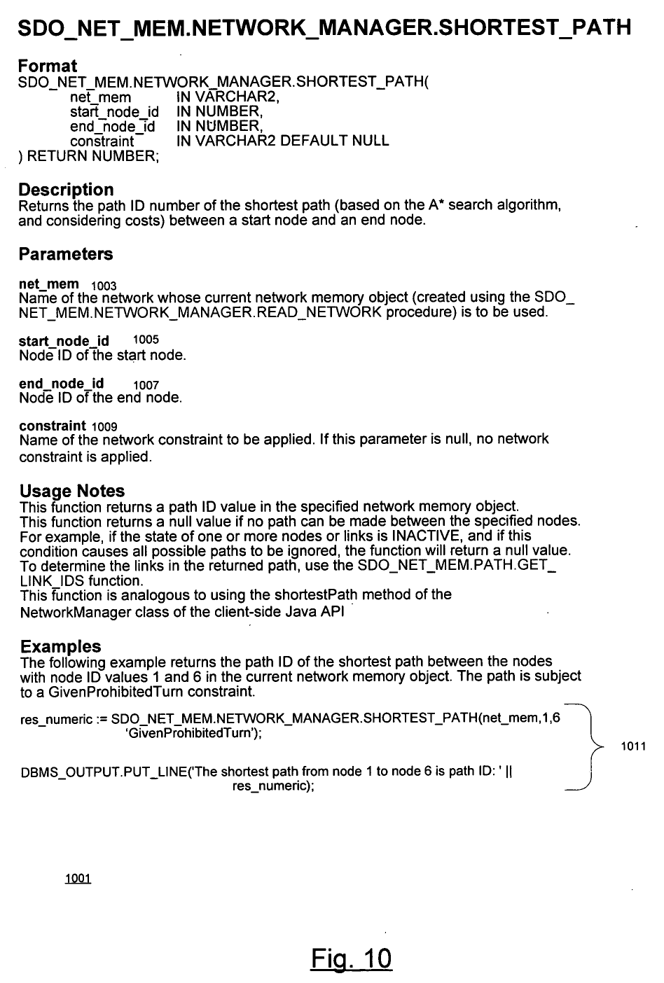

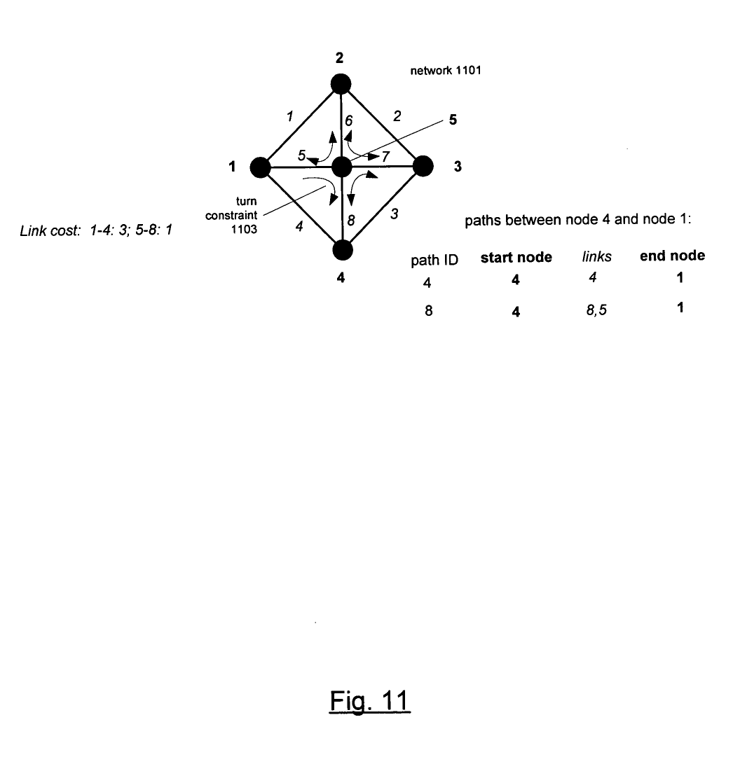

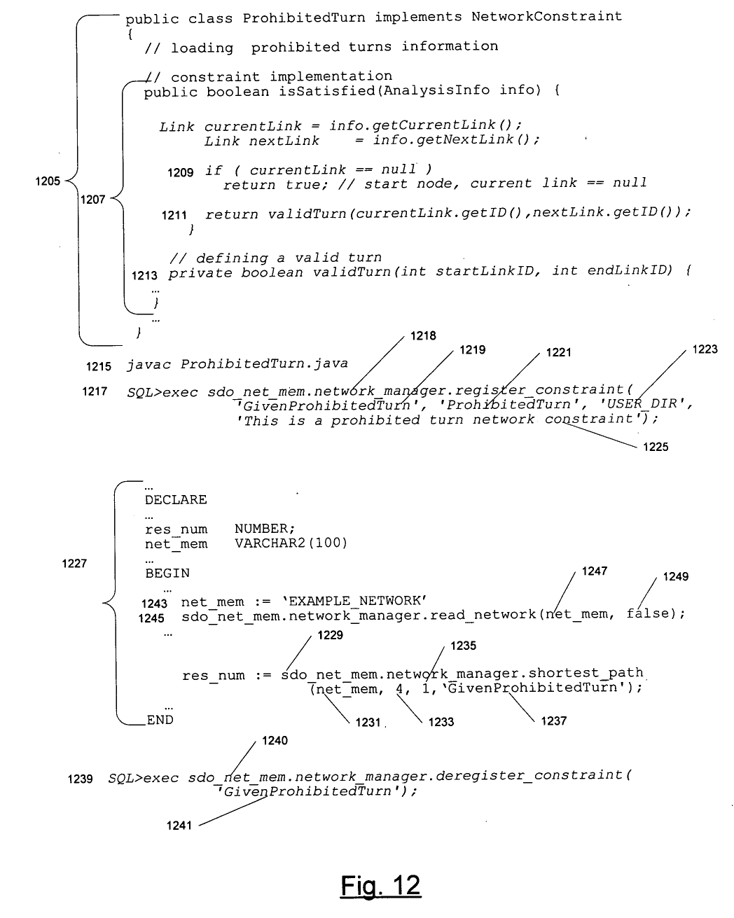

Using Network Constraints: FIGS. 10 and 12

FIG. 12 gives an example at 1217 of how SDO_NET_MEM.NETWORK_MANAGER. REGISTER_CONSTRAINT routine 1218 of the network data model PL/SQL API can be used to register a network constraint. The invocation of registration routine 1218 shown at 1217 takes four parameters: at 1219, the name that will be used as the constraint parameter specifying the network constraint in the PL/SQL analysis routine using the network constraint; at 1221 the name of the Java class file for the constraint; at 1223 the name of a directory in file system 745 that contains the java class file, and at 1225 a description of the network constraint. The information in the parameters is used to create a row for the constraint in SDO_NETWORK_CONSTRAINTS table 901 as follows: sdo_owner 905 is set from system information about the entity for whom the registration routine has been invoked; constraint 907 is set from parameter 1219; description 909 is set from parameter 1225; class_name 911 is set from parameter 1221; parameter 1221 and parameter 1223 are used to locate the .class file for the constraint in file system 745 and the contents of the class file are copied into class 913. The PL/SQL routine 1240 for deregistering a network constraint is shown at 1239; it has only a single parameter 1241: the name by which the constraint is identified in base table 901. When routine 1240 is executed by the owner of the constraint, the row of table 901 having that owner and that constraint name is deleted from base table 901 and thereby from views 917 and 921.

In network PL/SQL API 717, a constraint may be specified in the invocation of a routine that performs a network analysis operation by means of a constraint parameter in the invocation. The parameter is a character string which appears in constraint field 907 in a row of NDM network constraint table 901.

FIG. 10 presents details of one of the PL/SQL network analysis wrappers, SDO_NET_MEM.NETWORK_MANAGER.SHORTEST_PATH. Wrapper 1001 is a PL/SQL function that returns the path ID number of the shortest path (based on the A* search algorithm and considering the costs of the paths) between a start node and an end node. As shown in FIG. 10, function 1001 has four parameters:
net_mem 1003: Name of the network which has been copied into the current network memory object in cache 715 (created using the PL/SQL API's SDO_NET_MEM.NETWORK_MANAGER.READ_NETWORK procedure).
start_node_id 1005: Node ID of the start node of the nodes between which the shortest path is to be computed.
end_node_id 1007: Node ID of the end node of the nodes between which the shortest path is to be computed.
constraint 1009: Name of the network constraint to be applied in computing the shortest path. If this parameter is null, no network constraint is applied.
   When an invocation of the shortest path function is executed, the function determines the shortest path between the start node specified by parameter 1005 and the end node specified by parameter 1007 in the network specified by parameter 1003. If parameter 1009 is not null, the function applies the constraint specified by the parameter in making the computation of the shortest path.

FIG. 11 provides an example network 1101 which has been represented in server 702 using the network data model. Network 1101 has five nodes and 8 links. The IDs of the nodes appear in bold face next to the node; the IDs of the links appear in italic next to the link. As indicated at the left of network 1101, each of links 1-4 has a cost of 3, while each of links 5-8 has a cost of 1; consequently, if cost is taken into account, the shortest path between any of nodes 1-4 is by way of node 5.

In the example, we are interested in the shortest path between node 4 and node 1; as shown at the right of network 1101, two paths are defined between these nodes: path 4, which starts at node 4 and goes to node 1 by link 4, and path 8, which goes by link 8, node 5, and link 5. There is further a constraint on network 11; the constraint is shown by the arrow at 1103; it is namely forbidden to make a left turn from link 8 onto link 5 at node 5; turns may otherwise be made in any direction from a link at node 5, as indicated by the single-headed arrow 1103 for the constraint and the double-headed arrows for other links and directions at node 5. As is clear from the link cost and path information for network 1101, absent constraint 1103, the shortest path from node 4 to node 1 is path 8, which runs from node 4 via link 8 to node 5 and from node 5 via link 5 to node 4. The cost of this path is 2, while the cost of path 4, from node 4 to node 1 via link 4, is 3. With constraint 1103, however, which bars the use of path 8, the shortest path is path 4.

FIG. 12 provides a sketch of a Java class definition of a constraint named ProhibitedTurn and an example of its use in a network analysis function that is applied to network 1101. The sketch of the class definition for ProhibitedTurn is shown at 1205. ProhibitedTurn is an implementation of the Java interface NetworkConstraint, which defines a general interface for network constraints. The implementation sketch has two parts: a public function isSatisfied 1207 which is accessible to anyone who has access to the class ProhibitedTurn and returns the Boolean value FALSE when a turn is prohibited and a private function validTurn 1213, which is accessible only within the class definition and which returns the Boolean value FALSE when a turn is not valid. is satisfied 1207 receives an info object as a parameter. The info object has methods for getting the current and next links of the current path. For each current link, next link pair, is_satisfied 1207 uses validTurn 1213 to check whether a constraint forbids going from the current link to the next link, as shown at 1211. At the node which is at the beginning of a path, there is at yet no current link, so no constraint on the next link will apply. This case is handled at 1209.

The class ProhibitedTurn is compiled by a java compiler at 1215 and then, as already described, the PL/SQL API is used at 1217 to register the class in NDM network constraint table 901. At 1227 is shown a fragment of PL/SQL code which reads the data that represents network 1101 in the network data model into cache 715 and then uses shortest path function 1229 to find the shortest path between nodes 4 and 1 of network 1101. Beginning at 1243, the assignment there sets the variable net_mem to the name by which network 1101 is known in the network data model. The read_network procedure of the PL/SQL API then reads the network specified by parameter 1247 into cache 715. Parameter 1249 indicates whether the copy in the cache is updatable; here, only analysis operations will be done, so it is not. Since the copy in the cache is not updatable, there is no need to either check the cached copy's consistency or update the network data 724 as the cached copy changes. Continuing with the invocation of the shortest path function at 1229, parameter 1231 specifies the memory object in cache 715 that contains the memory, at 1233, node 4 of network 1101 is specified as the start node, at 1235, node 1 of network 1101 is specified as the start node, and at 1237, the constraint is identified by the name it was registered under at 1217. Because of constraint 1103, the path ID returned by function 1229 will be 4 instead of 8. At 1239, finally, the PL/SQL API is used to deregister the constraint.

### CONCLUSION

The foregoing Detailed Description has disclosed the inventors' techniques for supplying a Java class to a Java routine that is being executed by a PL/SQL wrapper routine and an application of those techniques to supplying a network constraint to a Java routine being executed by a PL/SQL wrapper routine belonging to a network analysis API. The disclosure has been sufficient to permit those skilled in the relevant technologies to implement and use the techniques. The inventors have also disclosed the best mode presently known to them of implementing the techniques. It will however be immediately apparent to those skilled in the relevant techniques that the technique may be applied in any situation in which a PL/SQL wrapper routine must supply a class to a Java routine and that the implementation of the row source for the class information will depend on the situation in which the technique is being used. For example, in some embodiments, the row source may be a table function rather than a base table or a view. Further, the information that is related to the parameter value in the row source will also depend on the situation in which the technique is being used. For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. Apparatus employed with a PL/SQL routine that is a wrapper for a Java routine to supply a Java class to the Java routine, the PL/SQL routine and the Java routine being executed in a relational database management system and the apparatus comprising:
a parameter value available to an execution of the PL/SQL routine that specifies the class that is to be supplied; and
a source of a row in the relational database management system, the row relating the parameter value to a class definition for the class that is to be supplied, the execution of the PL/SQL routine querying the source of the row using the parameter value and providing the related class definition to an execution of the Java routine for use therein.

2. The apparatus set forth in claim 1 wherein:
the execution of the PL/SQL routine is associated with an entity belonging to a set of entities that may execute routines in the relational database management system;
the row further relates one of the entities to the parameter value; and
the execution of the PL/SQL routine queries the source of the row using the parameter value and the entity associated with the execution.

3. The apparatus set forth in claim 1 further comprising:
a registration PL/SQL routine that creates the row in the row source in response to a specification of the class definition and the parameter value.

4. The apparatus set forth in claim 3 further comprising;
a deregistration PL/SQL routine that deletes the row from the row source in response to the parameter value.

5. The apparatus set forth in claim 1 wherein:
the row source has a plurality of the rows, each row relating one of a plurality of the parameter values to one of a plurality of the class definitions.

6. The apparatus set forth in claim 5 wherein:
there is a plurality of the PL/SQL routines.

7. The apparatus set forth in claim 6 wherein:
The plurality of PL/SQL routines belong to a network analysis API used in the relational database management system to analyze a network represented by data organized in tables of the relational database management system according to a network data model provided by the relational database system;
the parameter values specify network constraints used in network analysis;
the row source is part of the metadata for the network data model; and
the rows of the row source relate the parameter values to class definitions for the network constraints.

8. The apparatus set forth in claim 7 wherein:
each row of the row source further relates an owner of the class to the parameter value and the class definition; and
the metadata further includes a first writable view of the row source which includes rows belonging to a given owner, the rows of the first view including the parameter values and the class definitions and
a second read only view of the row source which includes all of the rows, the rows of the second view including the parameter value but neither the owner nor the class definition.

9. The apparatus set forth in claim 8 wherein:
the first view is accessible only to the given owner; and
the second view is accessible to any user of the network data model.

10. The apparatus set forth in claim 8 wherein:
each row of the row source further relates a name for the class and a description of the constraint to the parameter value;
the rows of the first view further include the name for the class and the description of the constraint; and
the rows of the second view further include the name for the class and the description of the constraint.

11. The apparatus set forth in claim 10 wherein the plurality of PL/SQL routines further comprise:
a registration PL/SQL routine that creates a row in the row source in response to a specification of the class definition, the constraint definition, the class name, and the parameter value for the class; and
a deregistration PL/SQL routine that deletes the row from the row source in response to a specification of the parameter value.

12. A method employed in a relational database management system that is executing a PL/SQL routine that is a wrapper for a Java routine of supplying a Java class to an execution of the Java routine that corresponds to the execution of the PL/SQL routine, the method comprising the steps performed in the execution of the PL/SQL routine of:
receiving a parameter value, the parameter value specifying the class that is to be supplied;
using the parameter value in a query on a row source that returns a row in the relational database management system, the row relating the parameter value to a class definition for the class that is to be supplied; and
providing the class definition related to the parameter value to the execution of the Java routine.

13. The method set forth in claim 12 wherein:
the execution of the PL/SQL routine is associated with an entity belonging to a set of entities that may execute routines in the relational database management system;
the row further relates one of the entities to the parameter value; and
in the step of using the parameter value in a query, the execution of the PL/SQL further uses the entity associated with the execution.

14. The method set forth in claim 12 further comprising the step performed in the relational database management system prior to the execution of the PL/SQL routine of:
creating the row in the row source in response to a specification of the class definition and the parameter value.

15. The method set forth in claim 14 further comprising the step performed in the relational database management system after the execution of the PL/SQL routine of:
deleting the row in the row source in response to the parameter value.

16. The method set forth in claim 12 wherein:
the row source has a plurality of the rows, each row relating one of a plurality of the parameter values to one of a plurality of the class definitions.

17. The method set forth in claim 16 wherein:
there is a plurality of the PL/SQL routines.

18. The method set forth in claim 17 wherein:
The plurality of PL/SQL routines belong to a network analysis API used in the relational database management system to analyze a network represented by data organized in tables of the relational database management system according to a network data model provided by the relational database system;
the parameter values are names of network constraints used in network analysis;
the row source is part of the metadata for the network data model; and
the rows of the row source relate the parameter values to class definitions for the network constraints.

19. The method set forth in claim 18 wherein
each row of the row source further relates an owner of the class to the parameter value and the class definition; and the method further comprises the steps performed prior to or after the execution of the PL/SQL routine of:
making a first writable view of the row source which belongs to the metadata and includes rows belonging to a given owner, the rows of the first view including the parameter values and the class definitions; and
making a second read only view of the row source which belongs to the metadata and includes all of the rows, the rows of the second view including the parameter value but neither the owner nor the class definition.

20. The method set forth in claim 19 wherein:
each row of the row source further relates a name for the class and a description of the constraint to the parameter value;
in the step of making the first writable view, the rows of the first view of the row source further include the name for the class and the description of the constraint; and
the rows of the second view of the row source further include the name for the class and the description of the constraint.

21. The method set forth in claim 20 further comprising the steps performed in the relational database system of:
accessing the first view, the first view being accessible only to the given owner; and
accessing the second view, the second view being accessible to any user of the network data model

22. The method set forth in claim 20 further comprising the steps performed in the database management system of:
creating a row for a class in the row source in response to a specification of the class definition, the constraint definition, the class name, and the parameter value for the class; and
deleting the row in response to a specification of the parameter value.

23. A data storage device which may be accessed by a processor, the data storage device being characterized in that:
the data storage device contains code which, when executed by the processor, performs the method set forth in claim 12.

24. A method employed in a relational database management system that includes a network data model wherein a network is represented by data contained in tables and a PL/SQL API for network analysis that is implemented using a set of PL/SQL routines that are wrappers for Java routines, the method permitting a routine of the set of PL/SQL routines to provide a Java class implementation of a network constraint belonging to a set of network constraints to an execution of a Java routine that corresponds to the execution of the PL/SQL routine, the method comprising the steps performed in the execution of the PL/SQL routine of:
receiving a parameter value belonging to a set thereof, each parameter value specifying a network constraint of the set of network constraints;
using the parameter value in a query on a row source wherein each row relates a parameter value belonging to the set thereof to a Java class definition that implements the network constraint specified by the parameter value, the query returning the Java class definition related to the parameter value; and
providing the related Java class definition to the execution of the Java routine.

25. The method set forth in claim 24 further comprising the step performed in the relational database management system prior to the execution of the PL/SQL routine of:
creating the row in the row source in response to a specification of the class definition and the parameter value.

26. The method set forth in claim 25 further comprising the step performed in the relational database management system after the execution of the PL/SQL routine of:
deleting the row in the row source in response to the parameter value.
